(19) United States
(12) Patent Application Publication
(10) Pub. No.: US 2012/0194755 A1
(43) Pub. Date: Aug. 2, 2012

(54) Ultrafast twisted nematic liquid crystal display

(75) Inventor: Jianmin Chen, Louisville, CO (US)

(73) Assignee: RealD Inc., Beverly Hills, CA (US)

(21) Appl. No.: 13/359,462

(22) Filed: Jan. 26, 2012

Related U.S. Application Data
(60) Provisional application No. 61/436,953, filed on Jan. 27, 2011.

(51) Int. Cl. G02F 1/133

(52) U.S. Cl. 349/34

(57) ABSTRACT

A method for recovering a latent response time period of a TN liquid crystal cell may include determining a time period which may be related to a back flow effect of the TN liquid crystal cell. Recovering the latent response time period may be correlated to the time at which a voltage may be applied across the TN liquid crystal cell. The method may include applying the voltage to the TN liquid crystal cell during a display region in which both the right and left signals may be displayed or a region in which the content may not be appropriately viewable. By applying the voltage early to the TN liquid crystal cell, a resulting transmission “bump” may not optically contaminate the viewable content.

### CROSS-REFERENCE TO RELATED APPLICATIONS

This application claims priority to U.S. Provisional Patent Application Ser. No. 61/436,953, filed Jan. 27, 2011, entitled “Ultrafast twisted nematic liquid crystal display,” the entirety of which is herein incorporated by reference.

### TECHNICAL FIELD

The present disclosure generally relates to displays, and more specifically, to two dimensional and three dimensional display technologies and components including optical shutters and liquid crystals.

### BACKGROUND

Generally, current display technologies may include functionality to deploy, view and/or display three dimensional (“3D”) content. Recently, the increased demand for such functionality has driven the need for enhanced performance of display technology. Conventional display technology may employ the use of plasma and liquid crystal displays (“LCDs”) in conjunction with active liquid crystal (“LC”) shutters. Liquid crystal shutters may be employed in display design with minimal changes to the design and accordingly, a lower cost impact. Additionally, liquid crystals may be compatible with both two dimensional (“2D”) and 3D technologies. Furthermore, any additional component such as, but not limited to active shutter eyewear may be sold as a peripheral component.

Advances in technology have included, among others, a shifting trend from using super-twisted nematic liquid crystals (“STN”) to employing twisted nematic (“TN”) liquid crystals.

Additionally, STN liquid crystal displays may exhibit performance deficiencies which include, but are not limited to, a yellowish appearance in a white state, high operating voltages, and a relatively poor field of view (“FOV”).

### BRIEF SUMMARY

According to the present disclosure, a method for recovering a latent response time period of a liquid crystal display may include identifying a first display region of the liquid crystal display in which both a first signal and a second signal are substantially displayed, identifying a second display region of the liquid crystal display in which one of the first signal or second signal is displayed, and applying a voltage to a TN liquid crystal cell substantially for an approximate predetermined time at a time substantially occurring during the first display region. The method may include determining the approximate predetermined time at least by accounting for a back flow effect of the TN liquid crystal cell and may substantially prevent optical contamination during the second display region.

Additionally, the back flow effect of the TN liquid crystal cell further comprises allowing light to leak through the TN liquid crystal cell. The method may also include suppressing the back flow effect of the TN liquid crystal cell at least by increasing a chiral dopant concentration in which the chiral dopant concentration may be increased in a range such that the thickness of the TN liquid crystal cell divided by the chiral pitch is approximately 0.25. Furthermore, the method may include decreasing a response time of the liquid crystal display to an approximate range of 0.5 milliseconds to two milliseconds. In one embodiment, the method may substantially suppress the back flow effect of the TN liquid crystal cell by coordinating a time at which a liquid crystal display backlight is turned off. The method may allow a voltage to be applied such that a transmission bump occurs at least during a transition from the first display region to the second display region or may allow a voltage to be applied to the TN liquid crystal cell such that a transmission bump occurs substantially during the first display region.

According to the present disclosure, in another embodiment, a liquid crystal display may include a first substrate with at least a first side, a TN liquid crystal cell with a first side which may be located by the first side of the first substrate, in which the liquid crystal display may allow a first display region in which both a first signal and a second signal are substantially concurrently displayed, and the liquid crystal display may allow a second display region in which one of the first signal or second signal is displayed and a voltage may be applied to a TN liquid crystal cell for an approximate predetermined time at a time substantially occurring during at least the first display region, and a second substrate with a first side which may be located by a second side of the TN liquid crystal cell.

Continuing this embodiment, the approximate predetermined time may be determined at least by accounting for a back flow effect of the TN liquid crystal cell. The liquid crystal display may include an increased chiral dopant concentration to suppress the back flow effect of the TN liquid crystal cell, in which the chiral dopant concentration may be increased in a range such that the thickness of the TN liquid crystal cell divided by the chiral pitch may be approximately 0.25. A response time of the liquid crystal display may be decreased to an approximate range of 0.5 milliseconds to two milliseconds. Additionally, the back flow effect of the TN liquid crystal cell may be substantially suppressed by coordinating a time at which a liquid crystal display backlight is turned off. Furthermore, the voltage applied to the TN liquid crystal cell may be applied such that a transmission bump may occur substantially during the first display region.

According to the present disclosure, in another embodiment, a liquid crystal display system for recovering a latent response time period, may include a first lens and a second lens, in which the first and second lens may allow content to be viewed on a liquid crystal display, and a TN liquid crystal cell in which the liquid crystal display may allow a first display region in which both a first signal and a second signal may be substantially concurrently displayed, and the liquid crystal display may allow a second display region in which one of the first or second signal may be displayed, and a voltage may be applied to the TN liquid crystal cell for an approximate predetermined time at a time occurring during the first display region, in which the first lens and second lens may substantially block content from viewing during the first display region. The voltage to the TN liquid crystal cell may be applied such that a transmission bump may occur substantially during the first display region. Additionally, the left lens may be turned on approximately one millisecond earlier than the time at which a left signal is allowed on the display.

### BRIEF DESCRIPTION OF THE DRAWINGS

Embodiments are illustrated by way of example in the accompanying figures, in which like reference numbers indicate similar parts, and in which:

FIG. 1A is a schematic diagram illustrating one embodiment of a low voltage state for a specific LCD configuration, in accordance with the present disclosure;

FIG. 1B is a schematic diagram illustrating one embodiment of a high voltage state for a specific LCD configuration, in accordance with the present disclosure;

FIG. 2 is a graph of one embodiment of a TN liquid crystal response time curve, in accordance with the present disclosure;

FIG. 3A is a schematic diagram illustrating one embodiment of a high voltage state of a specific liquid crystal configuration, in accordance with the present disclosure;

FIG. 3B is a schematic diagram illustrating one embodiment a transition state of a liquid crystal molecule when an applied voltage changes, in accordance with the present disclosure;

FIG. 3C is a schematic diagram illustrating another embodiment of a transition state of a liquid crystal molecule when an applied voltage changes, in accordance with the present disclosure;

FIG. 3D is a schematic diagram illustrating one embodiment of a final state of a liquid crystal molecule orientation, in accordance with the present disclosure;

FIG. 4A is a graph of one embodiment of a TN response curve at various high voltage states, in accordance with the present disclosure;

FIG. 4B is a graph of one embodiment of a TN response curve at various high voltage states, in accordance with the present disclosure;

FIG. 5A is a schematic diagram illustrating one embodiment of a timing diagram for a conventional 3D display system, in accordance with the present disclosure;

FIG. 5B is a schematic diagram illustrating one embodiment of a timing diagram for a conventional 3D display system employing an active liquid crystal shutter, in accordance with the present disclosure;

FIG. 6A is a schematic diagram illustrating one embodiment of a timing diagram for a display system, in accordance with the present disclosure; and

FIG. 6B is a schematic diagram illustrating one embodiment of a timing diagram for a display system employing a liquid crystal shutter, in accordance with the present disclosure.

### DETAILED DESCRIPTION

Generally, one embodiment of the present disclosure may take the form of a method for recovering a latent response time period of a TN liquid crystal cell. The time period may be related to a back flow effect of the TN liquid crystal cell. Recovering the latent time period may be correlated to the time at which a voltage may be applied across the TN liquid crystal cell. In this embodiment, the method may be achieved by applying the voltage to the TN liquid crystal cell during a display region in which both the right and left signals may be displayed or a region in which the content may not be appropriately viewable. By applying the voltage early to the TN liquid crystal cell, a resulting transmission “bump” may not optically contaminate the viewable content.

According to the present disclosure, a method for recovering a latent response time period of a liquid crystal display may include identifying a first display region of the liquid crystal display in which both a first signal and a second signal are substantially displayed, identifying a second display region of the liquid crystal display in which one of the first signal or second signal is displayed, and applying a voltage to a TN liquid crystal cell substantially for an approximate predetermined time at a time substantially occurring during the first display region. The method may include determining the approximate predetermined time at least by accounting for a back flow effect of the TN liquid crystal cell and may substantially prevent optical contamination during the second display region.

Additionally, the back flow effect of the TN liquid crystal cell further comprises allowing light to leak through the TN liquid crystal cell. The method may also include suppressing the back flow effect of the TN liquid crystal cell at least by increasing a chiral dopant concentration in which the chiral dopant concentration may be increased in a range such that the thickness of the TN liquid crystal cell divided by the chiral pitch is approximately 0.25. Furthermore, the method may include decreasing a response time of the liquid crystal display to an approximate range of 0.5 milliseconds to two milliseconds. In one embodiment, the method may substantially suppress the back flow effect of the TN liquid crystal cell by coordinating a time at which a liquid crystal display backlight is turned off. The method may allow a voltage to be applied such that a transmission bump occurs at least during a transition from the first display region to the second display region or may allow a voltage to be applied to the TN liquid crystal cell such that a transmission bump occurs substantially during the first display region.

According to the present disclosure, in another embodiment, a liquid crystal display may include a first substrate with at least a first side, a TN liquid crystal cell with a first side which may be located by the first side of the first substrate, in which the liquid crystal display may allow a first display region in which both a first signal and a second signal are substantially concurrently displayed, and the liquid crystal display may allow a second display region in which one of the first signal or second signal is displayed and a voltage may be applied to a TN liquid crystal cell for an approximate predetermined time at a time substantially occurring during at least the first display region, and a second substrate with a first side which may be located by a second side of the TN liquid crystal cell.

Continuing this embodiment, the approximate predetermined time may be determined at least by accounting for a back flow effect of the TN liquid crystal cell. The liquid crystal display may include an increased chiral dopant concentration to suppress the back flow effect of the TN liquid crystal cell, in which the chiral dopant concentration may be increased in a range such that the thickness of the TN liquid crystal cell divided by the chiral pitch may be approximately 0.25. A response time of the liquid crystal display may be decreased to an approximate range of 0.5 milliseconds to two milliseconds. Additionally, the back flow effect of the TN liquid crystal cell may be substantially suppressed by coordinating a time at which a liquid crystal display backlight is turned off. Furthermore, the voltage applied to the TN liquid crystal cell may be applied such that a transmission bump may occur substantially during the first display region.

According to the present disclosure, in another embodiment, a liquid crystal display system for recovering a latent response time period, may include a first lens and a second lens, in which the first and second lens may allow content to be viewed on a liquid crystal display, and a TN liquid crystal cell in which the liquid crystal display may allow a first display region in which both a first signal and a second signal may be substantially concurrently displayed, and the liquid crystal display may allow a second display region in which one of the first or second signal may be displayed, and a voltage may be applied to the TN liquid crystal cell for an approximate predetermined time at a time occurring during the first display region, in which the first lens and second lens may substantially block content from viewing during the first display region. The voltage to the TN liquid crystal cell may be applied such that a transmission bump may occur substantially during the first display region. Additionally, the left lens may be turned on approximately one millisecond earlier than the time at which a left signal is allowed on the display

It should be noted that embodiments of the present disclosure may be used in a variety of optical systems and projection systems. The embodiment may include or work with a variety of projectors, projection systems, optical components, computer systems, processors, self-contained projector systems, visual and/or audiovisual systems and electrical and/or optical devices. Aspects of the present disclosure may be used with practically any apparatus related to optical and electrical devices, optical systems, presentation systems or any apparatus that may contain any type of optical system. Accordingly, embodiments of the present disclosure may be employed in optical systems, devices used in visual and/or optical presentations, visual peripherals and so on and in a number of computing environments.

Before proceeding to the disclosed embodiments in detail, it should be understood that the disclosure is not limited in its application or creation to the details of the particular arrangements shown, because the disclosure is capable of other embodiments. Moreover, aspects of the embodiment may be set forth in different combinations and arrangements to define embodiments unique in their own right. Also, the terminology used herein is for the purpose of description and not of limitation.

Generally, current display technologies may employ liquid crystal display (“LCD”) and plasma technologies with active liquid crystal (“LC”) shutters and these display technologies may use super-twisted nematic (“STN”) liquid crystals. STN liquid crystals may be employed due to a fast response time, as described in U.S. Pat. No. 4,884,876, U.S. Pat. No. 5,117,302 and U.S. Pat. No. 5,327,269, all of which are herein incorporated by reference in their entirety. Additionally, STN technology has advanced to improve performance, as described in pending U.S. Patent Application Publication No. U.S. 2009/0066863, which is herein incorporated by reference in its entirety. Additionally, displays employing STN liquid crystals have included compensation film and other components to overcome some of the issues encountered in these STN liquid crystal displays.

Further, improved performance in display technology may be achieved by using twisted nematic (“TN”) liquid crystals. The TN liquid crystal may have an approximately 90 degree twist or any other degree twist that may function similarly. For purposes of discussion, the following examples may refer to a TN LCD with a 90 degree twist.

One example of improved performance of a TN with a 90 degree twist liquid crystal display may be a substantially achromatic appearance of the display during a non activated state or dark state of the liquid crystal. Additionally, the low twist angle of 90 degrees of a TN liquid crystal compared to the usually greater than 200 degree twist angle of a STN liquid crystal may lead to a higher contrast at relatively low voltages. The lower voltages may be in the approximate range of five to fifteen volts. Additionally, a TN liquid crystal display may include a thin cell gap which may lead to a relatively better field of view than for a STN liquid crystal display. TN liquid crystal displays may exhibit slower response times than that of STN liquid crystal displays, which may lead to a relatively low brightness of the display system. In one example of a 3D application, a shutter open time may be approximately two and a half milliseconds while the response time of the TN liquid crystal display may be approximately three milliseconds or greater.

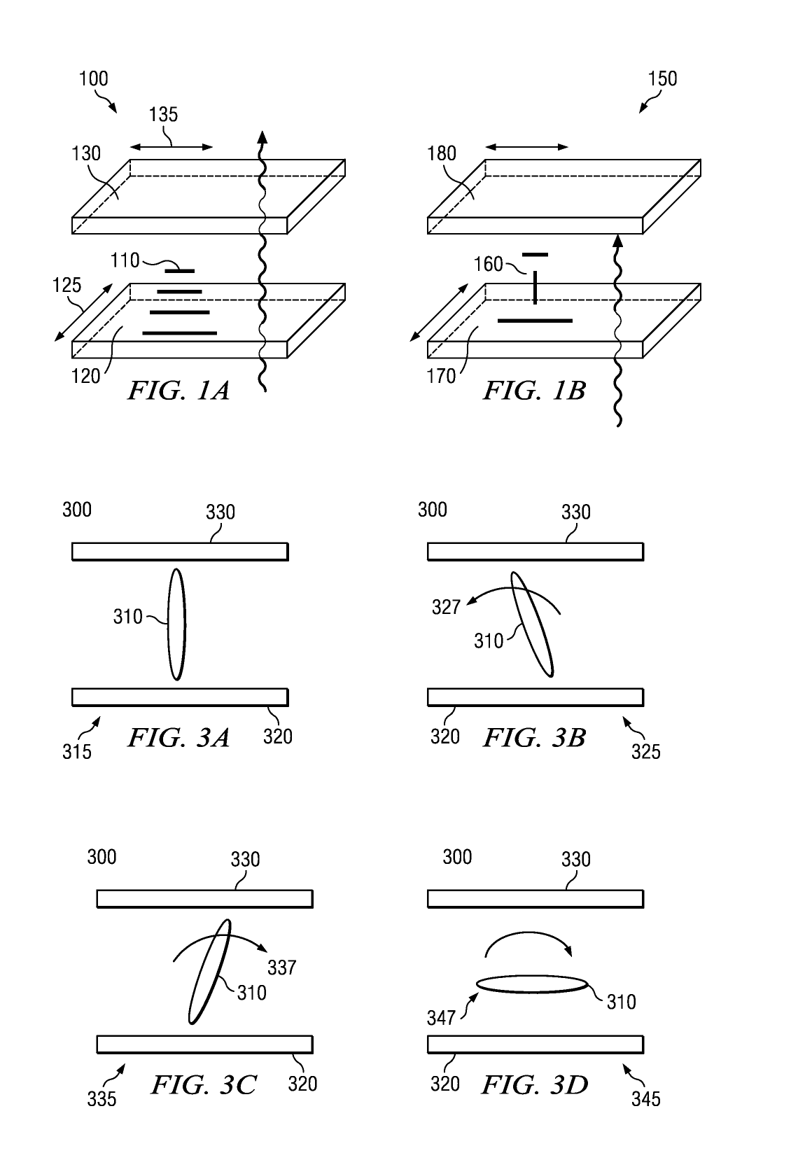

FIG. 1A is a schematic diagram illustrating one embodiment of a low voltage state for a specific LCD configuration. The configuration in FIG. 1A is a TN liquid crystal display 100 in which the TN liquid crystal may have a 90 degree twist and may be operated in a normal white mode. In FIG. 1A, the TN liquid crystal display 100 may include the TN liquid crystal 110 between two pieces of substrate. The substrates may be glass and the substrates may be polarized. As illustrated in FIG. 1A, the TN liquid crystal display 100 may include a first piece of polarized glass 120, which may be referred to herein as a polarizer 120 for purposes of discussion only. Also in FIG. 1A, the TN liquid crystal display 100 may include a second piece of polarized glass 130, which may be referred to herein as an analyzer 130 for purposes of discussion only. As shown in FIG. 1A, the polarizer 120 may be located at the input end of the TN liquid crystal display 100 and the analyzer 130 may be located at the output end of the TN liquid crystal display 100. Stated differently, light may enter at the polarizer end of the TN liquid crystal display 100 and given the appropriate conditions, light may exit at the analyzer end of the TN liquid crystal display 100.

As previously discussed with respect to FIG. 1A, and as shown in FIGS. 1A and 1B, the TN liquid crystal display may be operated in a normal white mode. Generally, in the normal white mode of a TN liquid crystal display, the transmission axis of the analyzer may be oriented perpendicular to the transmission axes of the polarizer. Also shown in FIG. 1A, the light may be polarized and may transmit through the TN liquid crystal display in a low and/or substantially zero voltage state. Generally and as illustrated in FIG. 1A, the low and/or substantially zero voltage state may be a voltage that may fail to cause the TN liquid crystal 110 to substantially rotate and/or switch to a different state. The state in which light transmits through a TN liquid crystal display may be referred to herein as a light state for discussion purposes only.

FIG. 1B is a schematic diagram illustrating one embodiment of a high voltage state for a specific LCD configuration. The LCD configuration of FIG. 1B is similar to the LCD configuration of FIG. 1A. In FIG. 1B, the TN liquid crystal display 150 may include a first a first piece of polarized glass 170, which may be referred to herein as a polarizer 170 for purposes of discussion only. Also in FIG. 1B, the TN liquid crystal display 150 may include a second piece of polarized glass 180, which may be referred to herein as an analyzer 180 for discussion purposes only. As shown in FIG. 1B, the polarizer 170 may be located at the input end of the TN liquid crystal display 150 and the analyzer 180 may be located at the output end of the TN liquid crystal display 150. Stated differently, light may enter at the polarizer end of the TN liquid crystal display 150 and given the appropriate conditions, light may exit at the analyzer end of the TN liquid crystal display 150.

As shown in FIG. 1B, the light may be polarized and may be blocked at the analyzer 180 in a high voltage state, thus the light may fail to transmit through the TN liquid crystal display 150. The high voltage state may generally be a voltage that may cause the TN liquid crystal 160 to substantially rotate and/or switch, as illustrated in FIG. 1B. The state in which light fails to transmit through a TN liquid crystal display may be referred to herein as a dark state.

Although FIGS. 1A and 1B describe a TN liquid crystal display operating in a normal light mode, the TN liquid crystal display may also operate in a normal dark mode. The normal dark mode may allow light to transmit through the TN liquid crystal display in a high voltage state and the light may fail to transmit through the TN liquid crystal display in a low and/or substantially zero voltage state. Additionally, in a normal dark mode, the transmission axis of the analyzer may be parallel to the transmission axis of the polarizer.

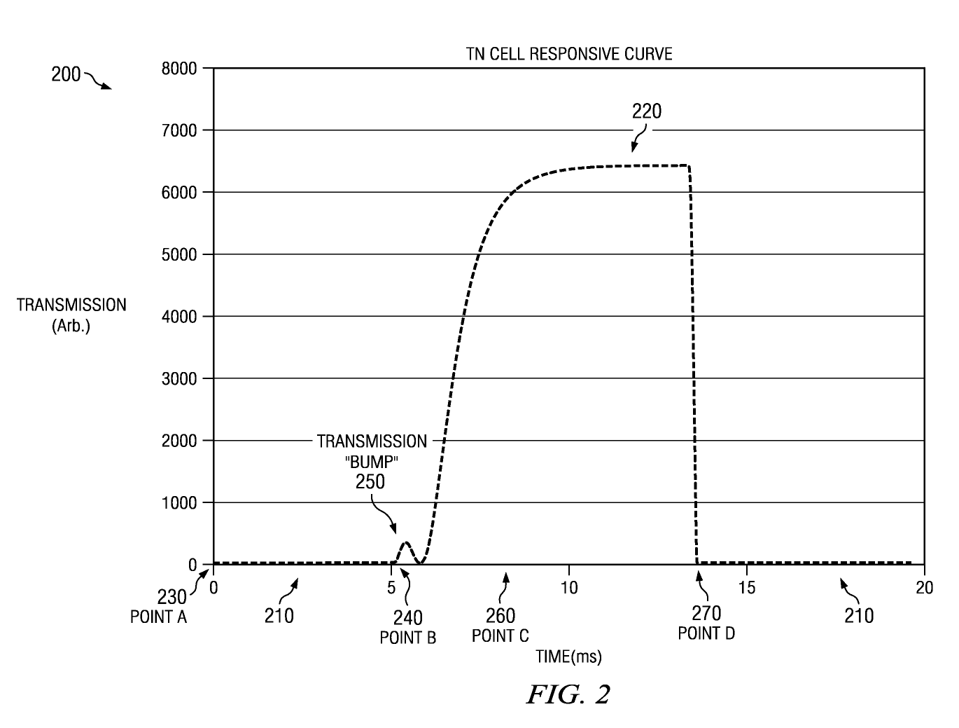

FIG. 2 is a graph illustrating one embodiment of a TN liquid crystal response time curve of a specific LCD configuration. The LCD configuration of FIG. 2 is a TN liquid crystal display in a normal white mode switching from a high voltage state to a low or substantially zero voltage state. As illustrated on the TN cell response curve 200 of FIG. 2, the high voltage state 210 may also be referred to herein as the dark state 210 and the low voltage state 220 may be referred to as the light state 220 for discussion purposes only.

As previously discussed, a TN liquid crystal display may have a slow response time. The response time of a TN liquid crystal may be greater than two and a half milliseconds. In one example, the TN liquid crystal response time may be greater than approximately three milliseconds.

At point A 230, the approximate start time of the graph or approximately time zero, in FIG. 2, the TN liquid crystal may have a high voltage applied across the cell and may be in a dark state 210. As shown in FIG. 2, at approximately point A 230 or approximately time zero, the transmission may be in the dark state 210 or approximately zero or low transmission, when compared to the light state 220. In FIG. 2, the voltage across the TN liquid crystal cell is reduced or turned off at a time at or before approximately point B 240. The term “point” may be used herein for discussion purposes only, but may refer to a point, an approximate section or region of the graph of FIG. 2.

As shown in FIG. 2, at approximately point B 240, a transmission “bump” 250 may be caused at some point after the voltage is reduced or turned off and before approximately point C 260. The transmission “bump” as illustrated in FIG. 2, may be a region in which light or content may be unintentionally allowed to pass through the TN liquid crystal cell. The transmission bump 250 may be caused from a back flow effect of liquid crystal molecules, which in turn, may affect the response time of the TN liquid crystal. The back flow effect will be discussed in more detail herein and with respect to FIG. 3. At around approximately point C 260, the TN liquid crystal cell may substantially return to the light state 220. In FIG. 2, at approximately point D 270, the voltage may be increased and/or turned on and the transmission may return to the dark state 210 and/or to a lower transmission than when a high voltage is applied across the TN liquid crystal cell.

FIGS. 3A, 3B, 3C, and 3D are schematic diagrams illustrating one embodiment of a response of a specific configuration of a liquid crystal to an applied voltage. The liquid crystal configuration 300 of FIGS. 3A, 3B, 3C and 3D are similar to that of FIGS. 1A and 1B and may be a TN liquid crystal operating in a normal light mode. The TN liquid crystal configuration of FIGS. 3A, 3B, 3C, and 3D may include at least a first piece of substrate 320 and a second piece of substrate 330, and as previously discussed with respect to FIGS. 1A and 1B, each of the first piece of substrate 320 and second piece of substrate 330 may be glass and may be polarized. Additionally, a TN liquid crystal cell may have various substrates or materials on either side of the TN liquid crystal and may have separate and/or multiple layers of glass, polarizer, substrate, spacers, and so forth, in any combination thereof on either or both sides of the TN liquid crystal. As previously discussed, although a normal light mode is discussed herein, it is for explanatory purposes only and may be a different mode such as a normal dark mode.

FIG. 3A is a schematic diagram illustrating one embodiment of a high voltage state of a specific liquid crystal configuration. FIG. 3A illustrates a TN liquid crystal 310 in state A 315, a high voltage state and/or when a high voltage is applied across the TN liquid crystal 310. Additionally, FIG. 3A illustrates the TN liquid crystal cell 310 before the voltage may be decreased and/or switched off and the TN liquid crystal 310 is in the black state. As shown in FIG. 3A, when a high voltage is applied to a TN liquid crystal 310, the LC cell may be homeotropically or vertically aligned. The homeotropic or vertical alignment of the liquid crystal cell may be referred to herein as state A 315. Generally, the TN liquid crystal may be referred to interchangeably herein as a liquid crystal molecule, a liquid crystal, a liquid crystal shutter, and so forth for discussion purposes only and not of limitation.

Next, FIG. 3B is a schematic diagram illustrating one embodiment of a transition state of a liquid crystal molecule when an applied voltage changes. FIG. 3B, is a similar configuration to FIG. 3A, but in a different transition state B 325. Accordingly, similar to FIG. 3A, FIG. 3B includes at least a first piece of substrate 320, a second piece of substrate 330 and a TN liquid crystal 310.

In the embodiment of FIG. 3B, the applied voltage may be decreased and/or switched substantially off and the TN liquid crystal may be in a transition state B 325. As shown in FIG. 3B, the liquid crystal molecule 310 may rotate the “wrong” direction 327 when the applied voltage is decreased and/or switched substantially off. The “wrong” direction 327 may be the opposite direction from the desired rotation direction. The liquid crystal molecule 310 may rotate in this incorrect direction at substantially the moment when the applied voltage may be decreased and/or switched substantially off or shortly thereafter. Additionally, the rotation of the liquid crystal molecule 310 in the “wrong” direction 327 before rotating to the “correct” direction, may lead to the transmission “bump” 250 approximately at or near the transition, as illustrated in FIG. 2.

Further, the liquid crystal may rotate from the original state A 315 as shown in FIG. 3A, rotate the “wrong” direction 327 as shown in FIG. 3B, and back to the original state A 315 as shown in FIG. 3A, which may be referred to herein as the flow back. The flow back illustrated in the transition state of FIG. 2 may last approximately one millisecond. Generally, the flow back may last an approximate range of 0.5 milliseconds to two milliseconds. The transition state illustrated in FIG. 3B may be referred to herein as state B 325.

FIG. 3C is a schematic diagram illustrating one embodiment of another transition state of a liquid crystal molecule when an applied voltage is changed. FIG. 3C, is a similar configuration to FIGS. 3A and 3B, but in a different transition state C 335. Accordingly, similar to FIGS. 3A and 3B, FIG. 3C includes at least a first piece of substrate 320, a second piece of substrate 330 and a TN liquid crystal 310. In this embodiment, the applied voltage is decreased and/or switched off and in a transition state C 335. As shown in FIG. 3C, after the liquid crystal molecule 310 rotates the “wrong” direction 327, as shown in FIG. 3B, the liquid crystal molecule 310 may switch to rotate the “correct” or desired direction 337. The transition state illustrated in FIG. 3C may be referred to herein as state C 335.

FIG. 3D is a schematic diagram illustrating one embodiment of a final state of the liquid crystal molecule orientation. FIG. 3D, is a similar configuration to FIGS. 3A, 3B, and 3C, but in a final state D 345. Accordingly, similar to FIGS. 3A and 3B, FIG. 3C includes a first piece of substrate 320, a second piece of substrate 330 and a TN liquid crystal 310. The final state D 345, as shown in FIG. 3D may be a light state, in which light may be transmitted through from a first end of the TN liquid crystal display and exiting the second end of the TN liquid crystal display. As illustrated in FIG. 3D, the TN liquid crystal 310 may be oriented such that light may transmit through the TN liquid crystal 310. The orientation of TN liquid crystal 310 may be referred to herein as orientation 347. The final state D 345 illustrated in FIG. 3D may be referred to herein as state D 345.

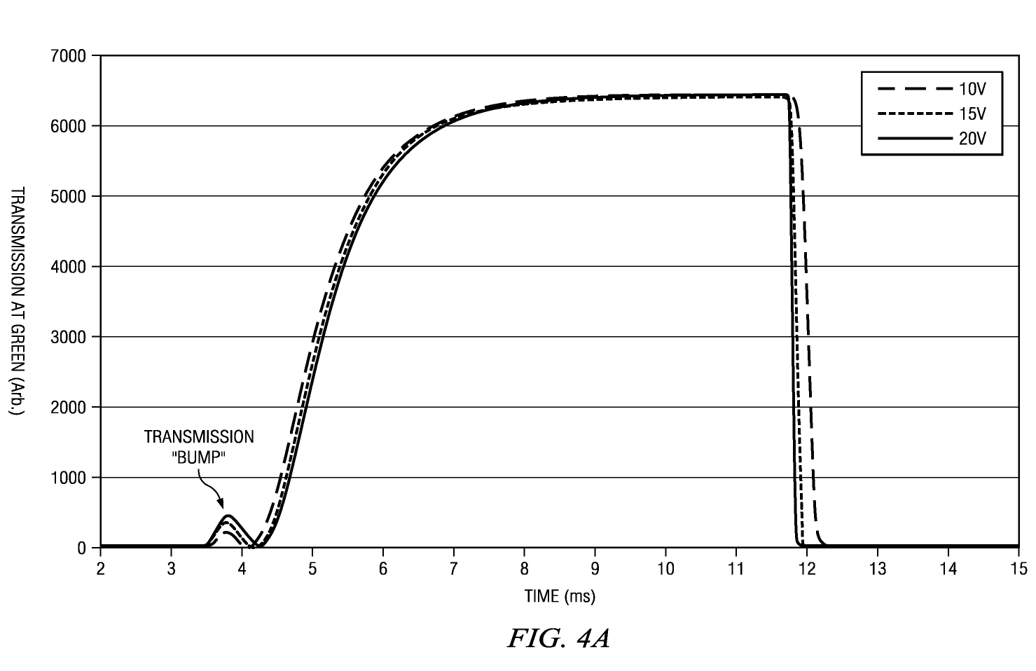

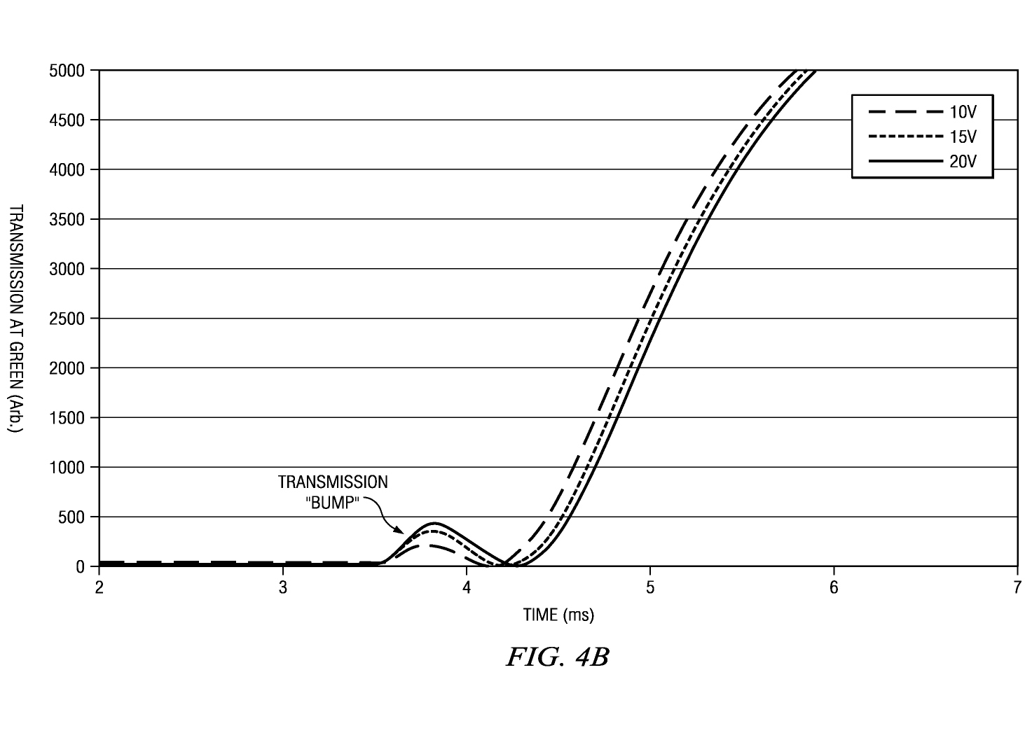

FIGS. 4A and 4B are schematic diagrams illustrating a graph of one embodiment of a TN liquid crystal response curve at various applied voltages. More specifically, FIG. 4B is an enlarged version of part of the graph of FIG. 4A. FIGS. 4A and 4B depict one embodiment of a method that may be used to suppress the liquid crystal back flow previously discussed. As shown in FIGS. 4A and 4B, at different applied voltages, the response time of the TN liquid crystal display may vary.

Generally, as the applied voltage decreases, then the amplitude of the transmission “bump” may also decrease. Additionally, as illustrated in FIG. 4A as the applied voltage decreases, the turn off response time of the TN liquid crystal may be slower. Stated differently, as the applied voltage changes from a low voltage to a high voltage, the TN liquid crystal switches from a light state to a dark state and as the high voltage limit decreases the TN liquid crystal switching time may increase.

In the embodiment of FIG. 4B, the transmission response of the TN liquid crystal is illustrated as applied voltages of approximately 10 Volts, 15 Volts, and 20 Volts are applied to the TN liquid crystal. As previously discussed, the amplitude of the transmission “bump” decreases as the applied voltage decreases. More specifically, in FIG. 4B, the amplitude of the transmission “bump” is the lowest at 10 Volts and the highest at 20 Volts. Additionally, in FIG. 4B, the curve includes the response at 10 Volts, 15 Volts, and 20 Volts and illustrates the slower turn off response time of the TN liquid crystal at 10 Volts than at 15 Volts and 20 Volts. Further illustrated in FIG. 4B, the turn off response time of the TN liquid crystal at 15 Volts is slower than at 20 Volts.

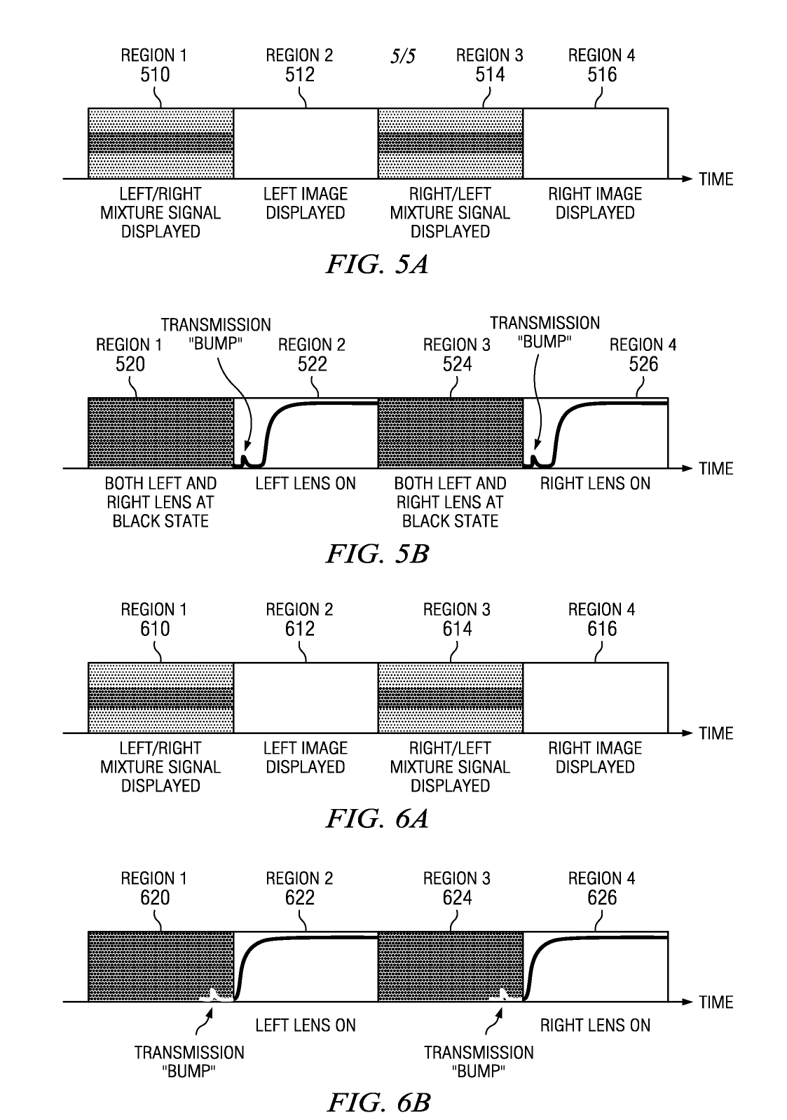

FIG. 5A is a schematic diagram illustrating one embodiment of a timing diagram for a conventional 3D display system. FIGS. 5A and 5B may be viewed on similar time graphs such that the different regions or stages may transition and occur at approximately the same time. FIG. 5A includes four different regions or stages. The first region or stage, Region 1 510 may be a mixture of signals in which both the left and the right signals may be approximately, concurrently displayed. Further, as the left and right signals display at approximately the same time, the content may not be viewable or recognizable as the intended content. In the second region or stage, Region 2 512, the left signal or image may be displayed and may be viewable, or the intended content may be viewable. In the third region or stage, Region 3 514, the left and right signals may be displayed at approximately the same time and again, the content may not be viewable or the content may not be recognizable as the intended content. During the fourth region or stage, Region 4 516, and similar to the Region 2 512, the right image may be displayed and viewable, or the intended content may be viewable. The viewing content, viewing display content, intended content or intended display content, which may be used interchangeably herein, may be, but are not limited to, moving images, still images, text, graphics, or any combination thereof, and so forth.

FIG. 5B is a schematic diagram illustrating one embodiment of a timing diagram for a conventional 3D display system. Again, FIGS. 5A and 5B may be viewed on approximately similar time graphs such that the different regions or stages may transition and occur at approximately the same time. Similar to FIG. 5A, FIG. 5B includes four different regions or stages. In FIG. 5B, the first region or stage, Region 1 520 illustrates that both the left lens and right lens may be at a dark state at substantially the same time. Stated differently, the TN liquid crystal may be in a state that substantially blocks light from passing through the TN liquid crystal cell, thus the content on the display may not be viewable through the right or left lens.

In the second region or stage, Region 2 522 of FIG. 5B, the left image may be displayed and may be ready for viewing. During the second region, the left image may be ready for viewing, thus the left lens may be in a light state so that the left signal or content may be viewed. In the third region or stage, Region 3 524, and similar to the Region 1 520 of FIG. 5B, both the left lens and right lens may be at a dark state at substantially the same time, and the intended display content may again, not be viewable. In the fourth region or stage, Region 4 526, the right lens may be in a light state so that the right signal or content may be viewed. Stated differently, the process may repeat itself and alternate for the left lens and left viewing content, and for the right lens and right viewing content.

FIG. 6A is a schematic diagram illustrating one embodiment of a timing diagram for a display system. FIGS. 6A and 6B may be viewed on substantially similar time graphs such that the different regions or stages may transition and occur at approximately the same time for discussion purposes only. Similar to FIG. 5A, FIG. 6A includes four different regions or stages. Region 1 510, 610 and Region 3 514, 614 of FIGS. 5A and 6A, respectively, illustrate a mixture of left and right signals that may display at approximately the same time. Although Region 1 510, 610 and Region 3 514, 614, respectively of FIGS. 5A and 6A show banding across Regions 1 and 3, the left and right signals may display in any manner, thus resulting in almost any pattern. The banding is one example of mixed content and for illustrative purposes only.

In FIG. 6A, the first region or stage, Region 1 610, may be a mixture of signals in which the left and the right signals are both approximately, concurrently displayed. Further in FIG. 6A, as the left and right signals display at approximately the same time and the left and right signals may be mixed, the content may not be appropriately viewable or the intended content may not be recognizable. In the second region or stage, Region 2, 612, the left image may be displayed and may be ready for viewing as the content may be appropriately viewable. In the third region or stage, Region 3 614, the left and right signals may be displayed at approximately the same time and again, the content may not be viewable or the intended content may not be recognizable since the left and right signals may be concurrently displayed. In the fourth region or stage, Region 4 616, the right image may be displayed and ready for viewing or the right content may be viewable.

FIG. 6B is a schematic diagram illustrating one embodiment of a timing diagram for a display system employing a liquid crystal shutter. FIG. 6B depicts one embodiment of a new driving time scheme to recover the latent response time which may be due to a back flow effect in a TN liquid crystal cell. In FIG. 6B, the TN liquid crystal response curve is illustrated in white and black for purposes of viewing ease and discussion only. In one embodiment, the response time of a TN liquid crystal display may be decreased to the approximate range of 0.5 milliseconds to two milliseconds.

FIG. 6B includes four different regions or stages. In FIG. 6B, the first region or stage, Region 1 620 illustrates that both the left lens and right lens may both be at a dark state at substantially the same time. Stated differently, the TN liquid crystal shutter may be in a state that substantially blocks light from passing through the TN liquid crystal or the applied voltage across the TN liquid crystals is such that the right and left lenses are both in a dark state at substantially the same time. Although in FIG. 6B, region 1 620 illustrates the right and left lenses in a dark state, one or both of the TN liquid crystals of the right and left lenses may be in stage B, as discussed with respect to FIGS. 3A-3D. Stated differently, although either or both of the lenses may be turned on and may be exhibiting a transmission “bump”, either or both of the lenses may still be in a dark state such that the display content may be not be viewable. As discussed herein, a voltage may be applied or the voltage state may be changed to affect the state of the TN liquid crystal.

For example, in the embodiment of FIGS. 6A and 6B, the voltage may be decreased or turned off which may “turn on” the right and/or left lenses and allow light to pass through. Further, as the left and right lenses are at a dark state at approximately the same time, the display content may not be viewable. Prior to the second region or stage Region 2 622, an applied voltage may be decreased and/or not applied to the TN liquid crystal such that the left lens may be turned on and so that the left content may be viewed once the display transitions to display the left content. As shown in FIG. 6B, the left lens may be turned on in the Region 1 620 so that the transmission “bump” may occur in the Region 1 620. Moreover, in one example, the applied voltage may be decreased or substantially turned off to the TN liquid crystal such that the left lens may be turned on approximately one millisecond before Region 2 622 or the region in which the left content is displayed. Additionally, the transmission “bump” occurs in the first region and the transmission contamination may be minimal and may be less than 0.15%.

Continuing the discussion of the embodiment of 6B, in the third region or stage Region 3 624, an applied voltage may be increased and/or applied across the TN liquid crystal cell such that the left and right lenses may both be in a dark state at substantially the same time, thus blocking the display content from being viewed. In this embodiment, the display content that may not be viewable may be the left and right signal displayed at approximately the same time and may not be appropriate for viewing the intended content. In the fourth region or stage Region 4 626, the voltage may be applied to the TN liquid crystal such that the right lens may be turned on, thus enabling the right display content to be viewed.

In another embodiment of the present disclosure, the TN liquid crystal back flow may be suppressed by increasing the chiral dopant concentration. In this embodiment, the TN liquid crystal may have a twist angle of approximately ninety degrees. Additionally, the approximately ninety degree twist angle of the TN liquid crystal is discussed herein for explanatory purposes and the TN liquid crystal may have other twist angles as appropriate. The chiral dopant concentration may be increased in a range such that the thickness of the TN liquid crystal cell divided by the chiral pitch is approximately 0.25. The pitch of the chiral may refer to the approximate distance in which the TN liquid crystal molecules may undergo an approximately 360 degree twist. Additionally, the chiral pitch may change as molecules are added to the TN liquid crystal which may allow the pitch of the TN liquid crystal to be tuned to a desired value.

Continuing the discussion of this embodiment, by modifying the chiral dopant concentration, the response time of the TN liquid crystal may be decreased. In one example, by modifying the chiral dopant concentration, the TN liquid crystal molecules may rotate the “wrong” direction at a comparatively decreased angle, thus decreasing the response time of the

TN liquid crystal. In another example, with a modified chiral dopant concentration, the TN liquid crystal molecules may rotate the “wrong” direction faster, thus rotating in the “correct” direction faster and decreasing the response time of the TN liquid crystal. Although the rotation of the TN liquid crystal molecules was discussed with respect to chiral dopant concentration, a similar discussion may be appropriate for reducing the applied voltage to switch the TN liquid crystal to a dark or black state.

In another embodiment of the present disclosure, the TN liquid crystal back flow may be suppressed by coordinating the time at which the display backlight is turned off. In this embodiment and referring to FIG. 6A, the back light of the display may be switched off while the left and right signals are both displayed, such as Region 1 610 and Region 3 614. By switching the display backlight off, it may be possible to turn on the appropriate lens earlier. Although the appropriate lens may be turned on earlier, the contamination may be minimal as the transmission “bump,” as discussed with respect to at least FIGS. 4A and 4B, may occur substantially in the mixed signal regions or substantially during the transition between the mixed signal region to the left or right signal region. In one example of this embodiment, the left lens may be turned on approximately one millisecond earlier than the time at which the left signal may be displayed on the display.

As may be used herein, the terms “substantially” and “approximately” provide an industry-accepted tolerance for its corresponding term and/or relativity between items. Such an industry-accepted tolerance ranges from less than one percent to ten percent and corresponds to, but is not limited to, component values, angles, et cetera. Such relativity between items ranges between less than one percent to ten percent.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the embodiment(s) set out in any claims that may issue from this disclosure. Specifically and by way of example, although the headings refer to a “Technical Field,” the claims should not be limited by the language chosen under this heading to describe the so-called field. Further, a description of a technology in the “Background” is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

What is claimed is:

1. A method for recovering a latent response time period of a liquid crystal display, comprising:
identifying a first display region of the liquid crystal display in which both a first signal and a second signal are substantially concurrently displayed;
identifying a second display region of the liquid crystal display in which one of the first signal or second signal is displayed; and
allowing a voltage to be applied to a TN liquid crystal cell substantially for an approximate predetermined time at a time substantially occurring during at least the first display region.

2. The method for recovering a latent response time period of a liquid crystal display of claim 1, further comprising determining the approximate predetermined time at least by accounting for a back flow effect of the TN liquid crystal cell.

3. The method for recovering a latent response time period of a liquid crystal display of claim 1, wherein the back flow effect of the TN liquid crystal cell further comprises allowing light to leak through the TN liquid crystal cell.

4. The method for recovering a latent response time period of a liquid crystal display of claim 1, further comprising substantially preventing optical contamination during the second display region.

5. The method for recovering a latent response time period of a liquid crystal display of claim 1, further comprising suppressing the back flow effect of the TN liquid crystal cell at least by increasing a chiral dopant concentration.

6. The method for recovering a latent response time period of a liquid crystal display of claim 5, wherein the chiral dopant concentration is increased in a range such that the thickness of the TN liquid crystal cell divided by the chiral pitch is approximately 0.25.

7. The method for recovering a latent response time period of a liquid crystal display of claim 1, further comprising decreasing a response time of the liquid crystal display to an approximate range of 0.5 milliseconds to two milliseconds.

8. The method for recovering a latent response time period of a liquid crystal display of claim 1, further comprising substantially suppressing the back flow effect of the TN liquid crystal cell by coordinating a time at which a liquid crystal display backlight is turned off.

9. The method for recovering a latent response time period of a liquid crystal display of claim 1, wherein the voltage to the TN liquid crystal cell is applied such that a transmission bump occurs at least during a transition from the first display region to the second display region.

10. The method for recovering a latent response time period of a liquid crystal display of claim 1, wherein the voltage to the TN liquid crystal cell is applied such that a transmission bump occurs substantially during the first display region.

11. A liquid crystal display, comprising:
a first substrate with at least a first side;
a TN liquid crystal cell with a first side located by the first side of the first substrate, wherein the liquid crystal display allows a first display region in which both a first signal and a second signal are substantially concurrently displayed, and the liquid crystal display allows a second display region in which one of the first signal or second signal is displayed and a voltage is applied to a TN liquid crystal cell for an approximate predetermined time at a time substantially occurring during at least the first display region; and
a second substrate with a first side located by a second side of the TN liquid crystal cell.

12. The liquid crystal display of claim 11, wherein the approximate predetermined time is determined at least by accounting for a back flow effect of the TN liquid crystal cell.

13. The liquid crystal display of claim 11, further comprising an increased chiral dopant concentration to suppress the back flow effect of the TN liquid crystal cell.

14. The liquid crystal display of claim 13, wherein the chiral dopant concentration is increased in a range such that the thickness of the TN liquid crystal cell divided by the chiral pitch is approximately 0.25.

15. The liquid crystal display of claim 11, wherein a response time of the liquid crystal display is decreased to an approximate range of 0.5 milliseconds to two milliseconds.

16. The liquid crystal display of claim 11, wherein the back flow effect of the TN liquid crystal cell is substantially suppressed by coordinating a time at which a liquid crystal display backlight is turned off.

17. The liquid crystal display of claim 11, wherein the voltage applied to the TN liquid crystal cell is applied such that a transmission bump occurs substantially during the first display region.

18. A liquid crystal display system for recovering a latent response time period, comprising:
a first lens and a second lens, wherein the first and second lens allow content to be viewed on a liquid crystal display; and
a TN liquid crystal cell wherein the liquid crystal display allows a first display region in which both a first signal and a second signal are substantially concurrently displayed, and the liquid crystal display allows a second display region in which one of the first or second signal is displayed, and a voltage is applied to the TN liquid crystal cell for an approximate predetermined time at a time occurring during the first display region, wherein the first lens and second lens substantially block content from viewing during the first display region.

19. The liquid crystal display system for recovering a latent response time period of claim 18, wherein the left lens may be turned on approximately one millisecond earlier than the time at which a left signal is allowed on the display.

20. The liquid crystal display system for recovering a latent response time period of claim 18, wherein the voltage to the TN liquid crystal cell is applied such that a transmission bump occurs substantially during the first display region.
